(19) United States
(12) Patent Application Publication
(10) Pub. No.: US 2006/0203229 A1
(43) Pub. Date: Sep. 14, 2006

(54) Method and apparatus for inspecting defect in surface of metal roll

(75) Inventor: Fumio Gotoh, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/360,667

(22) Filed: Feb. 24, 2006

(30) Foreign Application Priority Data
Feb. 28, 2005 (JP) P.2005-053779

(51) Int. Cl. G01N 21/88

(52) U.S. Cl. 356/237.1

(57) ABSTRACT

A method for inspecting a defect in a surface of a roll, the method comprising: applying parallel light rays onto the roll which is rotating; projecting reflected light rays from the roll onto a screen; and detecting a defect from an image formed on the screen.

### FIELD OF THE INVENTION

The present invention relates to a metal roll surface defect inspection method and apparatus for optically inspecting a surface of a metal roll to detect a defect (such as dirt or damage) in the metal roll.

### BACKGROUND OF THE INVENTION

In a machine such as a calendering machine having a large number of rolls arranged for squeezing and smoothing a thin material and polishing the thin material, dirt or flaw in each roll is transferred to a production material to generate a defect. It is therefore necessary to inspect a surface of each roll to confirm the absence of any defect caused by the roll in an early stage of production before production is performed.

Generally, as the background art for inspecting the surface of an object, there are JP-A-7-229832 and JP-A-11-160243.

In the surface inspection method described in JP-A-7-229832, there are used: a light source for applying light onto a to-be-inspected object in a direction in which the light can be reflected from the to-be-inspected object; a direct reflection mirror disposed so that light reflected on a surface of the to-be-inspected object is made perpendicularly incident and perpendicularly reflected so as to be made incident again on the to-be-inspected object; a sensing device (TV camera) disposed in a position where re-reflected light of the light incident again on the to-be-inspected object can be captured, and provided for measuring brightness and darkness intensity of light; and an image processing device for detecting the surface property of the to-be-inspected object on the basis of the measured brightness and darkness intensity of light. Change in gloss irregularity of reflected light from the to-be-inspected object is emphasized to obtain a brightness and darkness pattern image to thereby eliminate lowering of contrast, missing of a fine-area defect and blurring of a boundary portion.

In the roll surface inspection method described in JP-A-11-160243, there are used: a TV camera having an optical axis arranged so as to be inclined at an angle of from 15° to 60° with respect to a line normal to the roll surface; and a projector for applying light on the roll in the same direction at an angle having a difference of not larger than 10° from the inclination angle of the optical axis of the TV camera so that the defect in the roll surface can be detected sensitively in an inline manner.

### SUMMARY OF THE INVENTION

Both the inspection methods described in JP-A-7-229832 and JP-A-11-160243 are however configured so that light reflected on the surface of the to-be-inspected object is directly accepted by the TV camera. If reflected light is directly accepted in this manner, it is very difficult to capture a fine concave and convex defect of the surface as a defect.

Moreover, because a defect on a two-dimensional plane is observed by the TV camera, a huge memory is required. In addition, it is necessary to provide a TV camera having a focal depth sufficiently large to observe a curved surface of the roll.

The invention is accomplished to solve the foregoing problem. An object of the invention is to provide a roll surface defect inspection method and apparatus in which dirt or flaw in a surface of a roll can be detected accurately without necessity of provision of any huge memory and any TV camera with a large focal depth.

(1) To solve the problem, the invention provides a method of inspecting a defect in a surface of a to-be-inspected roll, including the steps of: applying parallel light rays onto the to-be-inspected roll which is rotating; projecting reflected light rays from the to-be-inspected roll onto a screen; and detecting a defect from an image formed on the screen.

(2) The invention provides a method of inspecting a defect in a surface of a to-be-inspected roll according, to the paragraph (1), wherein the detection of a defect in the surface of the to-be-inspected roll is performed in such a manner that a plurality of rotations of the to-be-inspected roll are evaluated as one unit to thereby separate sporadic noise from a general defect.

(3) The invention provides a method of inspecting a defect in a surface of a to-be-inspected roll according to the paragraph (1) or (2), wherein the detection of a defect in the surface of the to-be-inspected roll is performed in such a manner that the to-be-inspected roll is rotated at a low velocity to perform accurate inspection at the time of start of the inspection, rotated at a high velocity to perform rough inspection during production and rotated at a low velocity again to perform accurate inspection before the termination of production.

(4) The invention provides a method of inspecting a defect in a surface of a to-be-inspected roll according to any one of the paragraphs (1) through (3), wherein the detection of a defect in the surface of the to-be-inspected roll is performed by sampling at intervals of predetermined rotations of the to-be-inspected roll.

(5) The invention provides a method of inspecting a defect in a surface of a to-be-inspected roll according to any one of the paragraphs (1) through (4), wherein production is stopped when a defect which may induce an image defect is detected.

(6) The invention provides an apparatus of inspecting a defect in a surface of a to-be-inspected roll, including: an irradiation device for applying parallel light rays onto the to-be-inspected roll; a screen onto which reflected light rays from the to-be-inspected roll are projected; and a photo acceptance device for fetching an image formed on the screen as a brightness and darkness signal.

(7) The invention provides an apparatus of inspecting a defect in a surface of a to-be-inspected roll according to the paragraph (6), wherein the screen is a white screen having high reflectance.

(8) The invention provides an apparatus of inspecting a defect in a surface of a to-be-inspected roll according to the paragraph (6) or (7), wherein the photo acceptance device is a line CCD camera.

(9) The invention provides a system for inspecting a defect in a surface of a to-be-inspected roll, including: an apparatus for inspecting a defect in the surface of the to-be-inspected roll according to any one of the paragraphs (6) through (8); and a personal computer, wherein: a brightness and darkness signal accepted by the photo acceptance device is judged by a threshold as to whether there is a defect or not; data are transmitted to the personal computer; and the data are processed by the personal computer.

(10) The invention provides a system for inspecting a defect in a surface of a to-be-inspected roll according to the paragraph (9), further including a memory for storing a result of the judgment.

(11) The invention provides a device for displaying a defect state of a surface of a to-be-inspected roll, including: a memory in which defect data indicating the position and size of each defect in the to-be-inspected roll are accumulated; a personal computer for processing the defect data; and a display for displaying a result of data processing executed by the personal computer, wherein: a map scene corresponding to widthwise and lengthwise directions of the to-be-inspected roll is displayed on the display; and an image of the defect is displayed in a position of the defect in the map scene.

(12) The invention provides a device for displaying a defect state of a surface of a to-be-inspected roll, including: a memory in which defect data indicating the position and size of each defect in the to-be-inspected roll are accumulated; a personal computer for processing the defect data; and a display for displaying a result of data processing executed by the personal computer, wherein: an address scene corresponding to widthwise and lengthwise directions of the to-be-inspected roll is displayed on the display; and an address value of the defect in the address scene is displayed with a color corresponding to the size of the defect.

As described above, the inspection of the roll surface according to the invention is performed in an inline manner in the condition that a light source for emitting parallel light rays is used as a light source while a line CCD camera is used as a photo acceptance device. Parallel light rays are applied on a calender roll. Reflected light rays from the calender roll are projected onto a ceramic screen. An image formed on the screen is picked up by the line CCD camera and processed.

If there is a defect such as dirt or flaw, a concave and convex portion is generated in the surface. For this reason, light in a portion of the defect is scattered so as to be projected as a dark portion on the screen. A judgment is made on the basis of the density and size of the detected dark portion as to whether the dark portion is a defect or not. When there is a defect, the defect is plotted on a map on a personal computer monitor in accordance with the defect level. The defect is visualized so that the shape of the defect can be confirmed. The operator can recognize the defect such as dirt or flaw while the defect is classified.

As described above, the invention is accomplished to pay attention to the fact that when light reflected on the roll is once projected onto the screen, light reflected on the concave and convex portion of the surface defect is scattered so as to be projected as a dark portion while light in the other portion is directly reflected so as to be projected as a bright portion. When an image formed on the screen is observed by the CCD camera in practice, a stripe portion can be clearly distinguished from the other portion. It has been first found that the invention can be put into practical use.

Accordingly, because this method is different from the method in which a defect on a two-dimensional plane is observed by the TV camera, it is not necessary to provide any huge memory. In addition, it is not necessary to provide any TV camera having a focal depth sufficiently large to observe the whole curved surface of the roll.

As another effect, the history of the production roll can be made clear when inspection is performed in the vicinity of the end of production in the same manner.

Moreover, production can be interrupted in the middle when large dirt to induce an image defect is detected. Accordingly, there can be provided inspection equipment taking one of assurances of the process in the calendering machine.

### BRIEF DESCRIPTION OF THE DRAWINGS

FIG. 1 is a perspective view showing an example of configuration of calender rolls to which an inspection apparatus according to the invention is applied.

FIG. 2 is a view for explaining the principle of inspection in the invention.

FIG. 3 is a perspective view of a system according to the invention in which one projector and one photo acceptance device are provided for performing inspection.

FIG. 4 is a plan view for explaining the operation of the inspection system depicted in FIG. 3.

FIG. 5 is an extended elevation corresponding to five rotations of a roll for explaining a condition for defect detection in the invention.

FIG. 6 is an overall configuration view of a system inclusive of the inspection apparatus according to the invention.

FIG. 7 shows an example of a photographic map scene used in the invention.

FIG. 8 shows an example of a detailed address scene used in the invention.

FIGS. 9A to 9C are views for explaining the threshold change timing executed in the invention.

### DESCRIPTION OF REFERENCE NUMERALS AND SYMBOLS

10: surface inspection apparatus according to the invention

11: light source for emitting parallel light rays

12: screen

13: line CCD camera

R1 to R4: roll

### DETAILED DESCRIPTION OF THE INVENTION

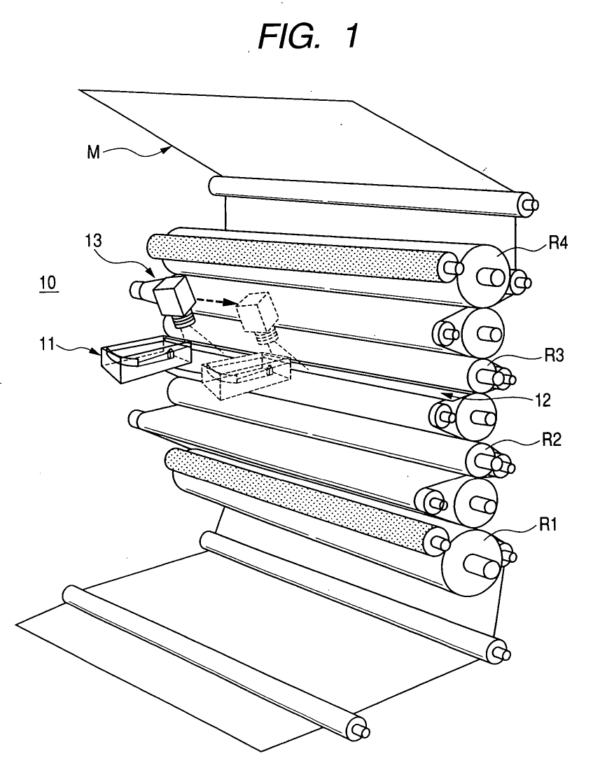

FIG. 1 shows an example of configuration of calender rolls to which the invention is applied.

The invention is configured so that a surface of a roll is inspected for early detection of a characteristic defect caused by the roll in a calendering step in a process of production of magnetic recording media. In a production apparatus shown in FIG. 1, a large number of calender rolls are arranged side by side so that a required process (flattening, smoothing, polishing, etc.) is applied to a magnetic tape while the magnetic tape is carried between adjacent ones of the calender rolls. Because dirt or damage of each roll is transferred to a production material to cause a defect, production is made after a surface of the roll is inspected to confirm that there is no defect caused by the roll in an early stage of production.

A roll surface inspection apparatus 10 according to the invention includes a light source 11 for emitting parallel light rays, a screen 12, and a line CCD camera 13. The roll surface inspection apparatus 10 is set for one (e.g. R3 in FIG. 1) of the rolls R1 to R4 which is a subject of inspection, so that a defect caused by the roll is managed.

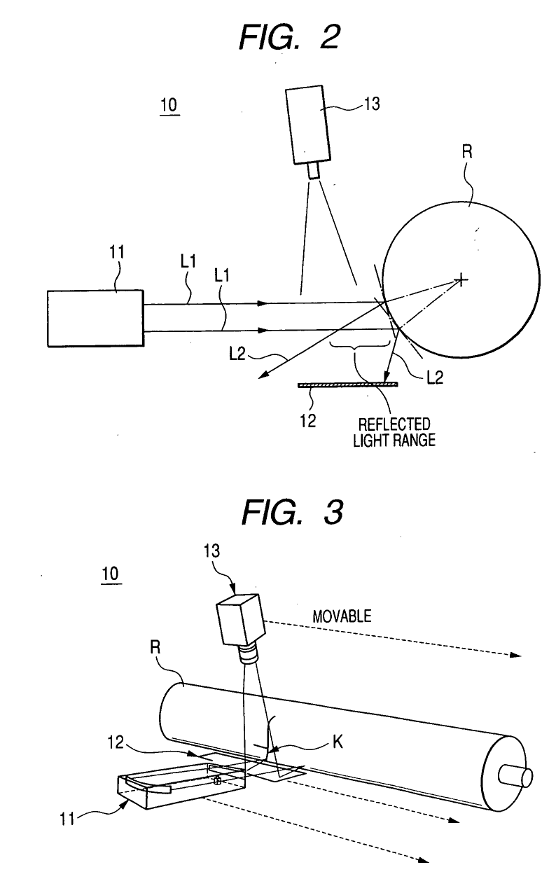

FIG. 2 is a view for explaining the principle of inspection according to the invention.

As shown in FIG. 2, the light source 11 for emitting parallel light rays is used as a light source, and the line CCD camera 13 is used as a photo acceptance device. First, parallel light rays L1 are applied on the to-be-inspected roll R. Reflected light rays L2 from a surface of the roll R are projected onto the ceramic screen 12. If dirt or damage is present in the roll surface, light applied on a portion of dirt or damage is scattered so that this portion is projected as a dark portion on the screen surface. On the other hand, light applied on a non-dirt or non-damage portion of the roll surface is reflected so that this portion is projected as a bright portion on the screen surface. Accordingly, the dark portion on the screen surface can be checked. If the dark portion is found, the case where the density and size of the dark portion exceed standard values is judged as a defect (NG).

The parallel light rays have a width of tens of mm (vertically). Because the light rays applied on a curved surface of the roll are largely widened as represented by a roll reflected light region, the line CCD camera 13 used as the photo acceptance device is set in a position where contrast can be obtained easily in the light rays projected on the ceramic screen 12.

The line CCD camera 13 captures the brightness and darkness on the ceramic screen 12 one-dimensionally and applies predetermined internal processing to an image waveform to amplify the brightness and darkness.

As described above, in accordance with the invention, delicate irregularity can be detected simply when the line CCD camera captures the brightness and darkness on the ceramic screen one-dimensionally. A great deal of memory necessary for a TV camera to observe a defect on a two-dimensional plane as described in JP-A-7-0229832 and JP-A-11-160243 can be dispensed with. Any expensive photo acceptance device with a focal depth large enough to observe the curved surface of the roll can be dispensed with.

FIG. 3 is a perspective view for explaining an inspection system according to the invention in which one projector and one photo acceptance device are provided for inspection.

Theoretically, a plurality of projectors and a plurality of photo acceptance devices may be arranged zigzag in two rows, i.e. in an odd-number row and in an even-number row, in the lengthwise direction of the roll while the roll is put between the two rows of the projectors and the photo acceptance devices (because the projectors emit parallel light rays so that it is difficult to execute inspection in the condition that the projectors are arranged in one row in the lengthwise direction of the roll) so that the whole roll can be inspected at once by simultaneous operations of the plurality of projectors and the plurality of photo acceptance devices. Such an inspection system is however expensive. Therefore, in inspection according to the invention, there is used a system in which the lengthwise direction of the roll is separated into several units so that inspection can be executed while one projector and one photo acceptance device are moved at intervals of one unit as shown in FIG. 3.

In FIG. 3, the projector 11 and the photo acceptance device 13 are moved while parallel light rays L1 are applied on the to-be-inspected roll R. Reflected light rays from the roll surface are projected onto the ceramic screen 12. If there is dirt or damage in the roll surface, light applied on a portion of dirt or damage is scattered so that this portion is projected as a dark portion on the screen surface. On the other hand, light applied on a non-dirt or non-damage portion of the roll surface is reflected so that this portion is projected as a bright portion on the screen surface. Accordingly, the dark portion on the screen surface can be checked. If the dark portion is found, the case where the density and size of the dark portion exceed standard values is judged as a defect (NG).

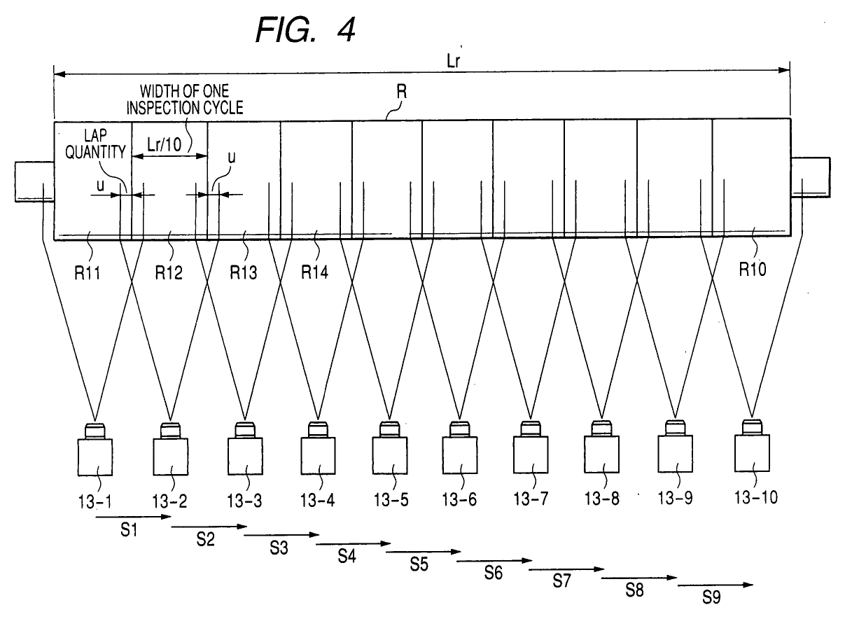

FIG. 4 is a plan view for explaining the operation of the inspection system depicted in FIG. 3.

In FIG. 4, when the whole length Lr (mm) of the roll R is divided equally into ten parts in the lengthwise direction of the roll R, the width of one inspection cycle is Lr/10 (mm). While one projector 11 and one photo acceptance device 13 are moved from left to right in FIG. 4 in the condition that light is applied and accepted with a width spread by a lap quantity u (mm) on either side with respect to the width of one inspection cycle, inspection is executed. Because the lap quantity u is provided, inspection can be performed without omission in the lengthwise direction of the roll R.

First, the photo acceptance device 13 is placed in a position 13-1, so that a region R11 of the roll R is inspected on the basis of acceptance of light reflected on the screen. The inspection of the region R11 of the roll R is not completed after one rotation of the roll R but completed after at least five rotations of the roll R so that data can be collected.

When the inspection of the region R11 of the roll R is completed, the projector 11 and the photo acceptance device 13 are moved right by Lr/10 (mm) from the position 13-1 to a position 13-2 so that a region R12 of the roll R is inspected.

This operation is repeated in positions 13-3, 13-4, . . . , 13-10. When the inspection of the last region of the roll R is completed, the inspection of the whole roll R is terminated.

As described above, in the invention, because the roll R is divided equally into ten parts in the lengthwise direction of the roll R, the visual field is set as Lr/10+2u (mm) and the effective visual field region is set as Lr/10 (mm).

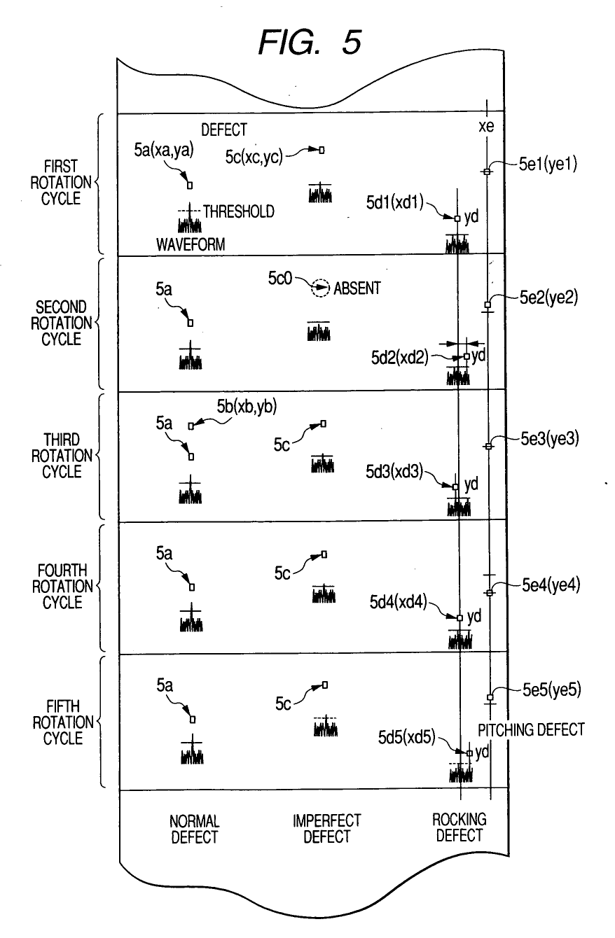

FIG. 5 is a view for explaining a condition for defect detection in the invention. That is, FIG. 5 is an extend elevation of the roll R with defect detection data at the time of five rotations of the roll R. The horizontal axis expresses the lengthwise direction of the roll R, and the vertical axis expresses a circumferential extended elevation corresponding to five rotations of the roll R. The reference numerals 5a, 5b, 5c, 5d and 5e designate flaws expressed as dark portions respectively.

The flaw 5a is a dark portion which is generated at a point of the same coordinates (xa, ya) in each of the first to fifth rotation cycles and which has a size exceeding a threshold.

The flaw 5b is a dark portion which is generated at a point of coordinates (xb, yb) only in the third rotation cycle and which is not generated in the other rotation cycles.

The flaw 5c is a dark portion which is generated at a point of the same coordinates (xc, yc) in each rotation cycle except the second rotation cycle and which has a size exceeding the threshold.

The flaw 5d (5d₁ to 5d₅) is a dark portion which is generated at a point of coordinates (xd, yd) in each of the first to fifth rotation cycles and which has a size exceeding the threshold. Moreover, yd in the coordinates (xd, yd) is constant but xd varies in the lengthwise direction of the roll R (i.e. xd₁≠xd₂≠xd₃≠xd₄≠xd₅ ).

The flaw 5e (5e₁ to 5e₅) is a dark portion which is generated at a point of coordinates (xe, ye) in each of the first to fifth rotation cycles and which has a size exceeding the threshold. Moreover, xe in the coordinates (xe, ye) is constant but ye varies in the circumferential direction of the roll R (i.e. ye₁≠ye₂≠ye₃≠ye₄≠ye₅).

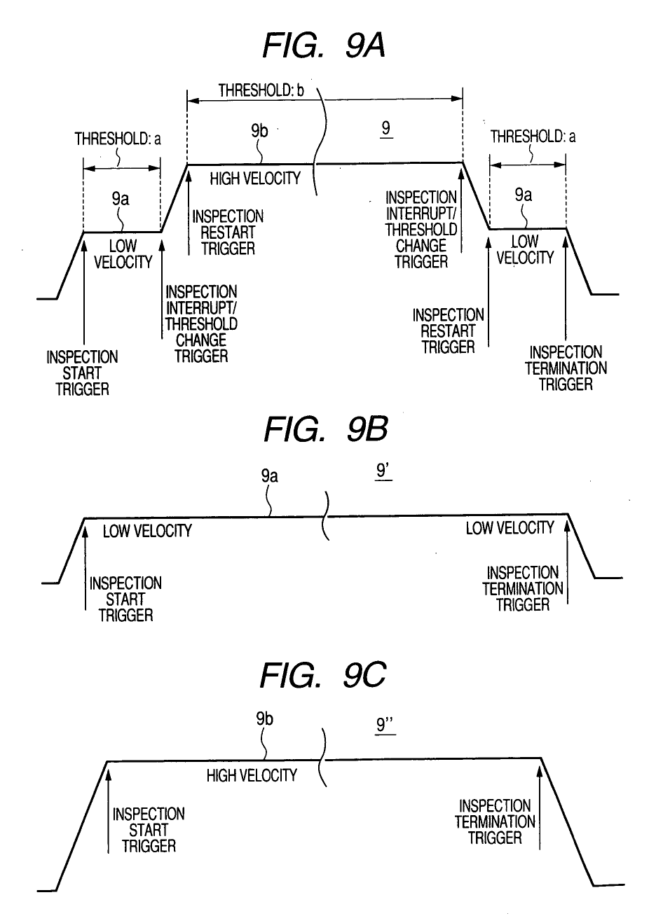

In this inspection, data corresponding to five rotations from the origin of rotation of the roll R are picked up from the equipment origin side at the time of low velocity (see FIGS. 9A to 9C). If a number of flaws corresponding to the number of rotations are detected at the same point (xa, ya) with respect to the position of rotation and the position of width as represented by the flaw 5a, this defect is described as “normal defect” and displayed on a map while classified in accordance with the density level.

The flaw 5b detected at the point of coordinates (xb, yb) in the inspection of the third rotation cycle on the same line is described as “noise” because it is sporadic. In this case, the flaw 5b is not judged to be a defect because the level of the noise is not larger than a predetermined level.

If flaws are not detected continuously but detected again (i.e. detected, not detected and detected) at the same point, that is, if an imperfect defect as detected in each rotation cycle except the second rotation cycle is detected as represented by the flaw 5c in FIG. 5, data is interpolated in the missing portion and then judgment is made because a defect is observed in view of the waveform but the density is delicate to be lower than the threshold so that the imperfect defect may be judged to be not a defect.

If the position of the flaw is displaced delicately in the axial direction of the roll in each rotation cycle as represented by the flaw 5d in FIG. 5, the flaw is described as “rocking defect”. The position of the flaw varies according to each inspection if there is delicate density irregularity in the size of the defect per se. Therefore, in this case, verification is performed in advance so that tolerance is used as a coefficient. If the displacement of the position is within the coefficient range, interpolation is performed while detected flaws are judged to be the same defect.

Moreover, when the position of the flaw is displaced delicately in the direction of rotation of the roll in each rotation cycle as represented by the flaw 5e, detected flaws are judged to be the same defect if the displacement of the position in the direction of rotation of the roll is within the tolerance range.

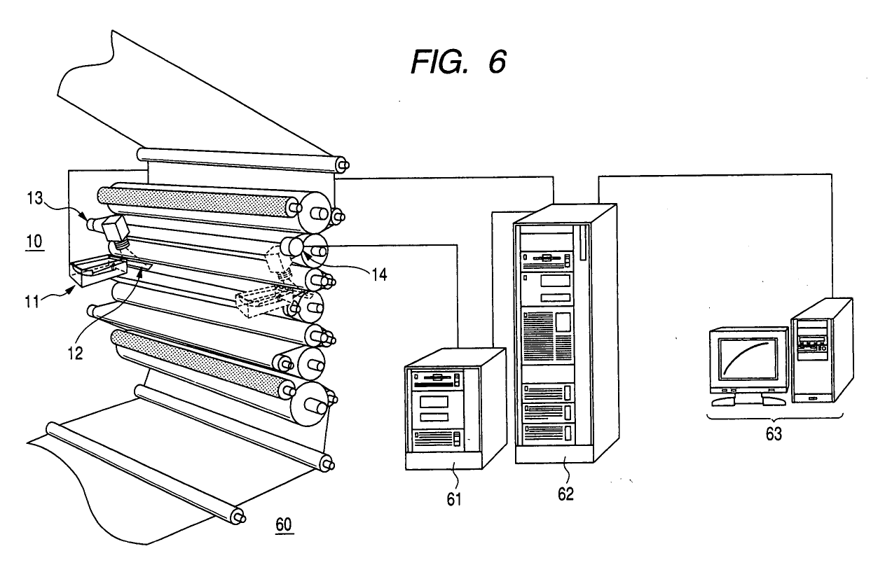

As shown in FIG. 6, the total system inclusive of the inspection apparatus includes a calendering machine 60, a servomotor control panel 61, an inspection apparatus control panel 62, and a data processing personal computer 63. The calendering machine 60 has a roll surface inspection apparatus 10. The roll surface inspection apparatus 10 has a parallel light emitting light source 11, a screen 12, a line CCD camera 13, and a servomotor 14 for moving the parallel light emitting light source 11, the screen 12 and the line CCD camera 13 integrally. The servomotor control panel 61 controls the servomotor 14 to move the projector 11 and the photo acceptance device 13. The inspection apparatus control panel 62 controls the inspection apparatus 10.

As described above, the projector 11 and the photo acceptance device 13 are integrated with the screen 12. The servomotor 14 for moving these devices 11 to 13 is controlled by the servomotor control panel 61 provided as an exclusive machine. An optical signal accepted by the line CCD camera 13 is subjected to predetermined processing in the inspection apparatus control panel 62 for controlling the inspection apparatus. Thus, resulting data are transmitted to the data processing personal computer 63.

A series of operations of the inspection apparatus is as follows. Upon reception of an inspection timing signal from the calendering machine as upper equipment, the inspection apparatus starts the inspection (FIG. 4) of the Lr/10 (mm) region of the first stage on the basis of a roll rotation origin signal. When the inspection (FIG. 5) corresponding to five rotations of the roll is completed, the inspection apparatus starts the inspection (FIG. 4) of the Lr/10 (mm) region of the second stage. In this manner, the inspection apparatus is shifted to the third stage, . . . , the tenth stage successively to perform inspection corresponding to five rotations of the roll.

The data processing personal computer 63 receives data each stage, processes the data sequentially and displays information of inspected regions.

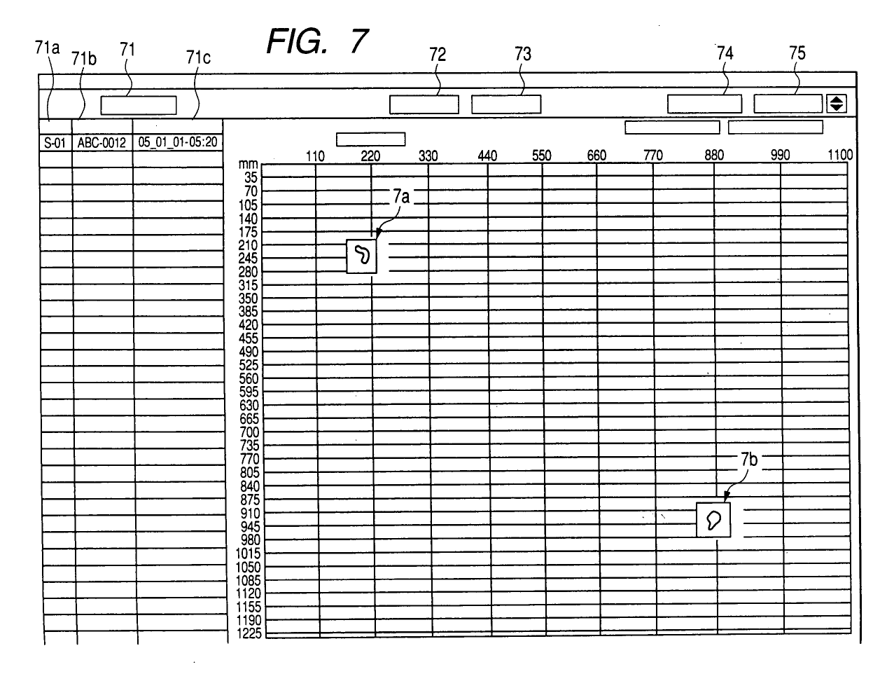

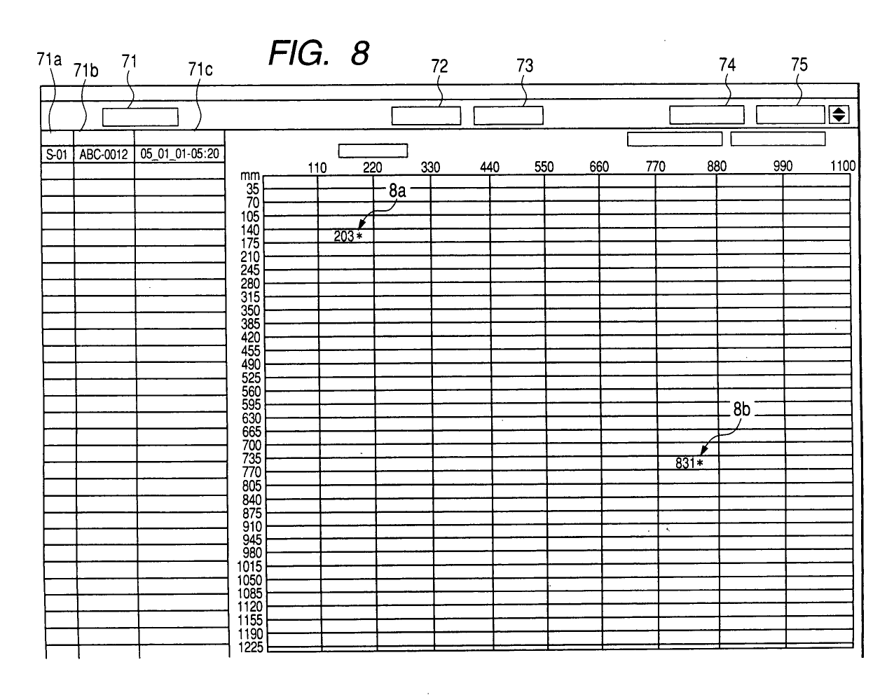

When the inspection of the tenth stage is completed, the data processing personal computer 63 (FIG. 6) processes the inspection data so that a “map” scene as shown in FIG. 7 and a “detailed address” scene as shown in FIG. 8 can be displayed.

In FIG. 7, the reference numeral 70 designates the “map scene”; 71, a file No. list; 71a, a roll number column; 71b, a product number column; and 71c, a production date column. The reference numeral 72 designates a “map scene” selection button; 73, a “detailed address” selection button; 74, a “present/past” selection button; and 75, a “scale-up/scale-down” button having an upward arrow (scale-up direction) and a downward arrow (scale-down direction).

When the “map scene” selection button 72 is clicked, the “map” scene shown in FIG. 7 appears. When the “detailed address” selection button 73 is clicked, the “detailed address” scene shown in FIG. 8 appears.

In the “map scene” shown in FIG. 7, the horizontal axis (X axis) expresses the widthwise position of the roll surface, and the vertical axis (Y axis) expresses the circumference of the roll. If there is a defect, an image of the defect is displayed at a point of intersection of the X and Y axes. Accordingly, the operator can confirm the kind (concave, convex, flaw, dirt, etc.) and size of the defect totally at a glance by watching the image of the defect.

At that time, in the “map” scene, the defect is classified according to the defect level and plotted. Accordingly, the operator can judge the defect accurately and rapidly.

Because the maximum of the Y axis is based on the circumference of the to-be-inspected roll, the numerical value displayed varies in accordance with the size of the roll. When the numerical value displayed needs to be scaled up, the scale-up button can be pushed to change the size to an arbitrary size.

When the inspection is completed in this manner, each image as a subject of detection is displayed on the map as represented by images 7a and 7b in FIG. 7. Accordingly, the operator can visually recognize this image as material to estimate a cause of generation of the defect.

In the “map” scene, detailed information of the position (address) of the roll surface is not displayed. Therefore, when surface position information needs to be found, it is necessary to display the “detailed address” scene shown in FIG. 8.

The entire layout of the “detailed address” scene is substantially the same as that of the “map” scene shown in FIG. 7. The duplicated description of these scenes will be omitted. The point of difference between these scenes is in that the position address of the roll surface is displayed in FIG. 8 instead of the defect image displayed in FIG. 7. That is, with respect to the position address of the roll surface, a numerical value “203” is displayed in the position of a portion 8a corresponding to the image 7a in FIG. 7, and a numerical value “831” is displayed in the position of a portion 9b corresponding to the image 7b in FIG. 7. Accordingly, the operator can find the respective addresses of defects accurately from the numerical values. An asterisk mark “*” following each numerical value means that an image of a corresponding defect can be displayed when the asterisk mark is clicked. Incidentally, the address of an end of the roll on the home station side is regarded as a zero point.

FIGS. 9A to 9C are views for explaining the timing for changing the threshold at the time of continuous inspection according to the invention. FIG. 9A shows an inspection method used in the invention. FIGS. 9B and 9C show inspection methods used generally.

In FIG. 9A, the reference numeral 9 designates a velocity graph of the to-be-inspected roll according to the invention. At the beginning and end of rotation of the to-be-inspected roll, accurate inspection is executed while the velocity of the roll is set at a low velocity (9a) and a threshold a for the low velocity is read. At the high velocity time during production, rough inspection is executed while the velocity of the roll is set at a high velocity (9b) and a threshold b for the high velocity is read. That is, the to-be-inspected roll is rotated. When the velocity of the roll reaches a predetermined low velocity (9a), an inspection start trigger is provided to start inspection. In this inspection, the threshold a is set at a low value to obtain such an accurate inspection state that even a fine defect can be captured. While the to-be-inspected roll makes several rotations, inspection data on the whole length of the roll are collected. When a large defect exceeding a predetermined size is detected as a result of the inspection, an alarm is given to the operator to urge the operator to clean or exchange the roll. If the defect size is smaller than the predetermined size, an inspection interrupt/threshold change trigger is provided to rotate the to-be-inspected roll at a high velocity (9b) to start production.

When the velocity of the roll reaches a predetermined high velocity, an inspection restart trigger is provided to restart inspection. In this inspection, the threshold is set at a high value b so that a large defect can be captured. When a large defect exceeding a predetermined size is detected at the time of production, an alarm is given to the operator to urge the operator to check the display screen.

When production is near completion, an inspection interrupt/threshold change trigger is provided to rotate the to-be-inspected roll at a low velocity (9a) again. When the velocity of the roll reaches the predetermined low velocity, an inspection restart trigger is provided to restart accurate inspection with a threshold a. In the accurate inspection, accurate inspection data on the whole length of the to-be-inspected roll are collected while the roll makes several rotations. When a large defect exceeding a predetermined size is detected as a result of the inspection, an alarm is given to the operator. If the detect size is smaller than the predetermined size, an inspection termination trigger is provided to stop the to-be-inspected roll and terminate the inspection. The defect inspection data are accumulated in the data processing personal computer 63 (FIG. 6).

On the contrary, FIG. 9B shows a velocity graph 9′ in the case where the to-be-inspected roll is inspected while the roll is always rotated at a low velocity. In FIG. 9B, accurate inspection is executed while the velocity of the to-be-inspected roll is always set at a low velocity (9a).

According to this inspection method, the to-be-inspected roll can be always accurately inspected but there is a problem in production efficiency, undesirably.

On the other hand, FIG. 9C shows a velocity graph 9″ in the case where the to-be-inspected roll is inspected while the roll is always rotated at a high speed. In FIG. 9C, rough inspection is executed while the to-be-inspected roll is always rotated at a high velocity (9b).

According to this inspection method, a large defect in the to-be-inspected roll can be inspected but a fine concave or convex defect is missed. Accordingly, there is a problem in quality, undesirably.

Accordingly, the inspection method according to the invention using FIG. 9A is an inspection method having both merits shown in FIGS. 9B and 9C. That is, the inspection according to the invention aims at detecting a fine defect. For this reason, accurate inspection is executed while the velocity of the to-be-inspected roll is set at a low velocity at the beginning and end of rotation of the roll as represented by the threshold change timing at the time of continuous inspection in FIG. 9A. On the other hand, rough inspection is executed at the high-velocity time of production while the velocity of the roll is set at a high velocity to improve production efficiency and a threshold for the high velocity is read. Accordingly, at the high velocity time, a fine defect cannot be recognized because inspection is performed for only a large defect. In the invention, accurate inspection is however performed before and after the rough inspection. Accordingly, when a fine defect is not generated based on accurate inspection before production but is detected by accurate inspection after production, the point of time of occurrence of the defect at the high velocity time can be deduced from the kind and size of the defect on the basis of the past defect accumulated data.

As occasion demands, setting may be made so that defect inspection is performed only at the low velocity time but inspection is not performed at the high velocity time.

The inspection cycles need not be continuous. The inspection cycles may be set at option in a sampling manner. When, for example, a roll 3000 m long is inspected at intervals of 500 m, six inspection cycles are required. Incidentally, repetitive inspection may be performed without awareness of the cycle length. In this case, when the remaining length is a low velocity region, repetitive inspection is not performed and inspection is interrupted to wait for a threshold change trigger.

As described above, dirt or flaw in the roll is transferred to a production material to generate a defect. Accordingly, a high-quality product (e.g. magnetic tape) can be obtained because production is performed after the roll surface is inspected to confirm that there is no defect caused by the roll in the early stage of production.

For example, a magnetic tape is produced by use of the roll. In the latest standard of the magnetic tape, nano-order concave and convex portions are required. It is however difficult to inspect the nano-order concave and convex portions in the magnetic tape. On the other hand, roll side concave and convex portions for stamping the nano-order concave and convex portions on the magnetic tape must be larger than the magnetic tape side concave and convex portions. The method according to the invention has an advantage because inspection of the concave and convex portions of the roll is easier than inspection of the concave and convex portions of the magnetic tape.

The inspection of the concave and convex portions of the magnetic tape is such one-chance inspection that any portion had to be inspected while it passes through the inspection apparatus once. On the contrary, the inspection of the concave and convex portions of the roll is repeatable inspection because any portion can make several rotations. Accordingly, the method according to the invention has an advantage in that a judgment can be made accurately as to whether the flaw is just noise or not.

Because accurate inspection (with a low threshold) is performed in the vicinity of the end of production in the same manner as at the beginning of production, the history of the production roll can be made clear.

Although this embodiment has been described on the case where the metal roll per se is inspected, the material of the roll is not limited to metal if the roll surface can reflect light. Accordingly, the invention can be practically applied not only to inspection of a calender roll but also to inspection of a roll at the time of production of the roll.

Because the image used for judging a defect is stored, there can be provided such a material that the quality control operator can judge the defect again after the fact and can analyze a cause of occurrence of the defect.

Although description has been made above on the case where a surface of a metal roll in a calendering machine used for production of a magnetic tape is inspected, it is a matter of course that the invention is not limited to inspection of the surface of the metal roll in the calendering machine, and that the invention may be applied to any inspection if the inspection is for the surface of the metal roll. For example, the technique according the invention is also useful for quality assurance in a process of production of the metal roll per se. The invention may be applied not only to the metal roll but also to any roll if the roll is made of a material capable of reflecting light.

This application is based on Japanese Patent application JP 2005-53779, filed Feb. 28, 2005, the entire content of which is hereby incorporated by reference, the same as if set forth at length.

What is claimed is:

1. A method for inspecting a defect in a surface of a roll, the method comprising:
applying parallel light rays onto the roll which is rotating;
projecting reflected light rays from the roll onto a screen; and
detecting a defect from an image formed on the screen.

2. The method according to claim 1, wherein the detection of a defect in the surface of the roll is performed by that a plurality of rotations of the roll are evaluated as one unit so as to separate sporadic noise from a general defect.

3. The method according to claim 1, wherein the detection of a defect in the surface of the roll is performed by that the roll is rotated at a low velocity to perform accurate inspection at the time of start of the inspection, rotated at a high velocity to perform rough inspection during production and rotated at a low velocity again to perform accurate inspection before the termination of production.

4. The method according to claim 1, wherein the detection of a defect in the surface of the roll is performed by sampling at intervals of predetermined rotations of the roll.

5. The method according to claim 1, wherein production is stopped when a defect which may induce an image defect is detected.

6. An apparatus for inspecting a defect in a surface of a roll, the apparatus comprising:
an irradiation device for applying parallel light rays onto the roll;
a screen onto which reflected light rays from the roll are projected; and
a photo acceptance device for fetching an image formed on the screen as a brightness and darkness signal.

7. The apparatus according to claim 6, wherein the screen is a white screen having high reflectance.

8. The apparatus according to claim 6, wherein the photo acceptance device is a line CCD camera.

9. A system for inspecting a defect in a surface of a roll, comprising: the apparatus as claimed in claim 6; and a personal computer, wherein: a brightness and darkness signal accepted by the photo acceptance device is judged by a threshold as to whether there is a defect or not; data are transmitted to the personal computer; and the data are processed by the personal computer.

10. The system according to claim 9, further comprising a memory for storing a result of the judgment.

11. A device for displaying a defect state of a surface of a roll, the device comprising:
a memory in which defect data indicating the position and size of each defect in the roll are accumulated;
a personal computer for processing the defect data; and
a display for displaying a result of data processing executed by the personal computer,
wherein: a map scene corresponding to widthwise and lengthwise directions of the roll is displayed on the display; and an image of the defect is displayed in a position of the defect in the map scene.

12. A device for displaying a defect state of a surface of a roll, the device comprising:
a memory in which defect data indicating the position and size of each defect in the roll are accumulated;
a personal computer for processing the defect data; and
a display for displaying a result of data processing executed by the personal computer,
wherein: an address scene corresponding to widthwise and lengthwise directions of the roll is displayed on the display; and an address value of the defect in the address scene is displayed with a color corresponding to the size of the defect.
